(19) United States
(12) Patent Application Publication
(10) Pub. No.: US 2004/0073573 A1
(43) Pub. Date: Apr. 15, 2004

(54) Product selection apparatus and method

(76) Inventor: Mark Hopkins, Sussex (GB)

Correspondence Address: Westman Champlin & Kelly, International Centre Suite 1600, 900 Second Avenue South, Minneapolis, MN, 55402-3319, US

(21) Appl. No.: 10/433,162

(22) PCT Filed: Dec. 3, 2001
(86) PCT No.: PCT/GB01/05332

(30) Foreign Application Priority Data
Dec. 1, 2000 (GB) 0029395.1
May 15, 2001 (GB) 0111884.3

(51) Int. Cl. G06F 7/00

(52) U.S. Cl. 707/104.1

(57) ABSTRACT

An apparatus and automated method of selecting a number of products from a plurality of products comprising the steps of: providing an information source having a respective product information for each of said plurality of products, each product information comprising a plurality of attribute values each relating to a respective attribute of the product: processing each product information so as to calculate a reduction benefit value for each attribute included in the information source wherein the reduction benefit value is a measure of the reduction in the number of products available for selection which will, on average, result if a selection is made between the attribute values in the information source for that attribute: automatically selecting the attribute with the reduction benefit value which provides the largest reduction: grouping the products according to their respective attribute value for the said automatically selected attribute so as to form a plurality of product groups: presenting the product groups for user selection therebetween: accepting the user selection of one or more products groups: and repeating the process until it is possible to present a sufficiently small number of products for final product selection.

The present invention relates to a product selection apparatus and method. Herein the word product includes non-physical products as well as physical products. A non-physical product might, for example, be a service product such as the provision of legal advice.

Modern advances in technology, particularly the Internet, have resulted in a vast increase in the amount of information potentially available to individuals especially when considered in terms of the relative ease of access to that information. This has expanded the range of products an individual has for selection between. However, the large range of products and abundant detailed information has resulted in increased difficulty in sifting through the large amount of information and large product range so as to locate the most suitable or desirable product.

Conventionally available Internet search engines are relatively inefficient and slavishly follow the users input, having no regard to whether or not the results are likely to be relevant. Typical of the frustrations encountered is the user who wishes to locate product information concerning, for example, a model of car called a “Tiger”. Searching on the word “Tiger” produces so many references to the animal called a Tiger that information relating to the model of car is unlikely to be found. Searching on the word “car” produces too many results to be useful. Searching on the expression “Tiger car”, or variations thereof, may still not produce the desired results, since the information sought will probably only refer to the model name and will not use the expression “Tiger car”. Also the results may still include many irrelevant results, such as those referring to cars which are used for tiger wildlife safaris or the like. An individual needs to become very expert before advance search techniques can be used to find quickly that which is required.

The above described difficulties are not mitigated to any significant extent, even in more mundane circumstances, such as using the web site of a particular department store or mail order company to select an everyday household item. Often the user is simply faced with a list of products to choose from, with little or no guidance in making a selection. A selection is based on a product type or category and is often made primarily on price. It is usually difficult to review product features, even if separate web pages are provided for each product and cross-comparing products is almost impossible. Some web sites offer a keyword search facility. The user types in words and a matching product is displayed. Here the results are often incorrect, or not optimal, due to the use of incorrect jargon. Often only one product will be identified (eg the first on the list), when there are actually a number which might be of interest (explicit or implicit) to choose between. Also the difficulty of cross-comparing still exists where more than one product is identified.

Against this background, the present invention seeks to provide a product selection apparatus and method which are easy to use, which better optimise the range of products from which a user makes a selection (not too broad and not too narrow) and which reach a final selection in an efficient manner.

Thus, according to a first aspect of the present invention there is provided an automated method of selecting a number of products from a plurality of products comprising the steps of:—

providing an information source having a respective product information for each of said plurality of products, each product information comprising a plurality of attribute values each relating to a respective attribute of the product;

processing each product information so as to calculate a reduction benefit value for each attribute included in the information source wherein the reduction benefit value is a measure of the reduction in the number of products available for selection which will, on average, result if a selection is made between the attribute values in the information source for that attribute;

automatically selecting the attribute with the reduction benefit value which provides the largest reduction;

grouping the products according to their respective attribute value for the said automatically selected attribute so as to form a plurality of product groups;

presenting the product groups for user selection therebetween;

accepting the user selection of one or more product groups;

re-calculating the reduction benefit values for the remaining attributes within the user selected product group or groups;

automatically selecting a remaining attribute, from the remaining attributes within the user selected product group or groups, with the reduction benefit value which provides the largest reduction;

grouping the products from the user selected product group or groups according to their respective attribute value for the said automatically selected remaining attribute so as to form a plurality of remaining product groups;

presenting the remaining product groups for user selection therebetween;

accepting the user selection of one or more remaining product groups; and

presenting the products of the user selected remaining product group or groups for final product selection by the user.

According to a second aspect of the present invention there is provided an apparatus for selecting a number of products from a plurality of products comprising:

storage means containing an information source having a respective product information for each of said plurality of products, each product information comprising a plurality of attribute values each relating to a respective attribute of the product;

processing means for processing each product information so as to calculate a reduction benefit value for each attribute included in the information source wherein the reduction benefit value is a measure of the reduction in the number of products available for selection which will, on average, result if a selection is made between the attribute values in the information source for that attribute;

selecting means for selecting automatically the attribute with the reduction benefit value which provides the largest reduction;

grouping means for grouping the products according to their respective attribute value for the said automatically selected attribute so as to form a plurality of product groups;

means for presenting the product groups for user selection therebetween;

means for accepting the user selection of one or more product groups;

re-calculating means which re calculate the reduction benefit values for the remaining attributes within the user selected product group or groups;

remainder selecting means for selecting automatically a remaining attribute, from the remaining attributes within the user selected product group or groups, with the reduction benefit value which provides the largest reduction;

remainder grouping means for grouping the products from the user selected product group or groups according to their respective attribute value for the said automatically selected remaining attribute so as to form a plurality of remaining product groups;

means for presenting the remaining product groups for user selection therebetween;

means for accepting the user selection of one or more remaining product groups; and

means for presenting the products of the user selected remaining product group or groups for final product selection by the user.

Embodiments of the present invention will now be described by way of further example only and with reference to the accompanying drawings, in which:—

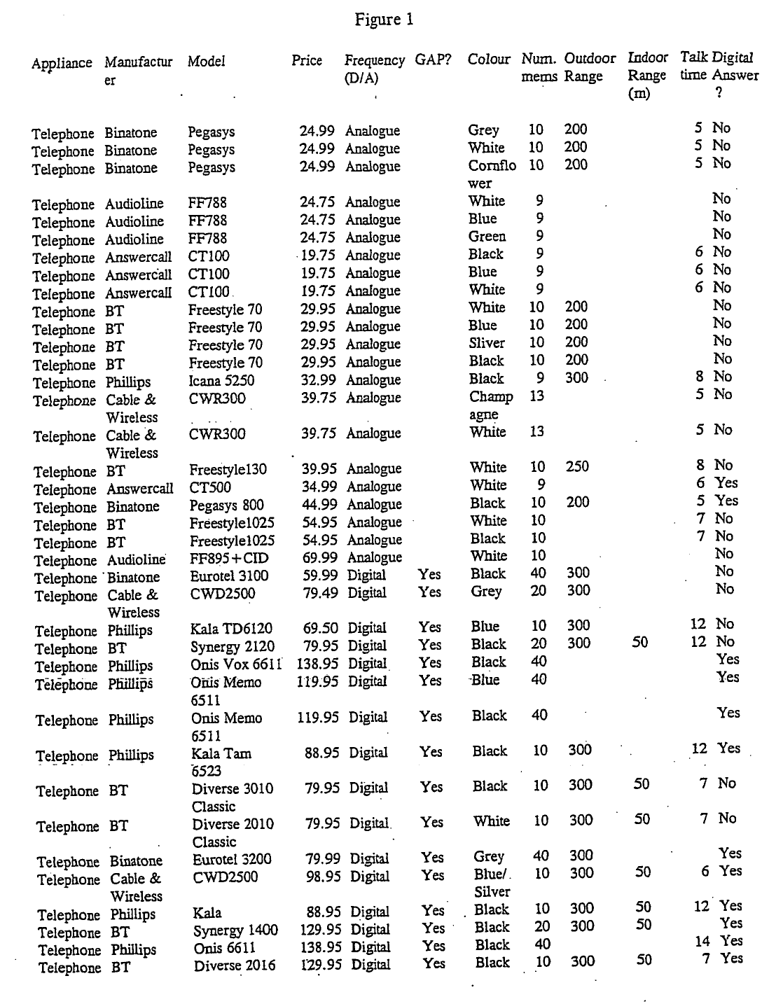

FIG. 1 is an example of an information source,

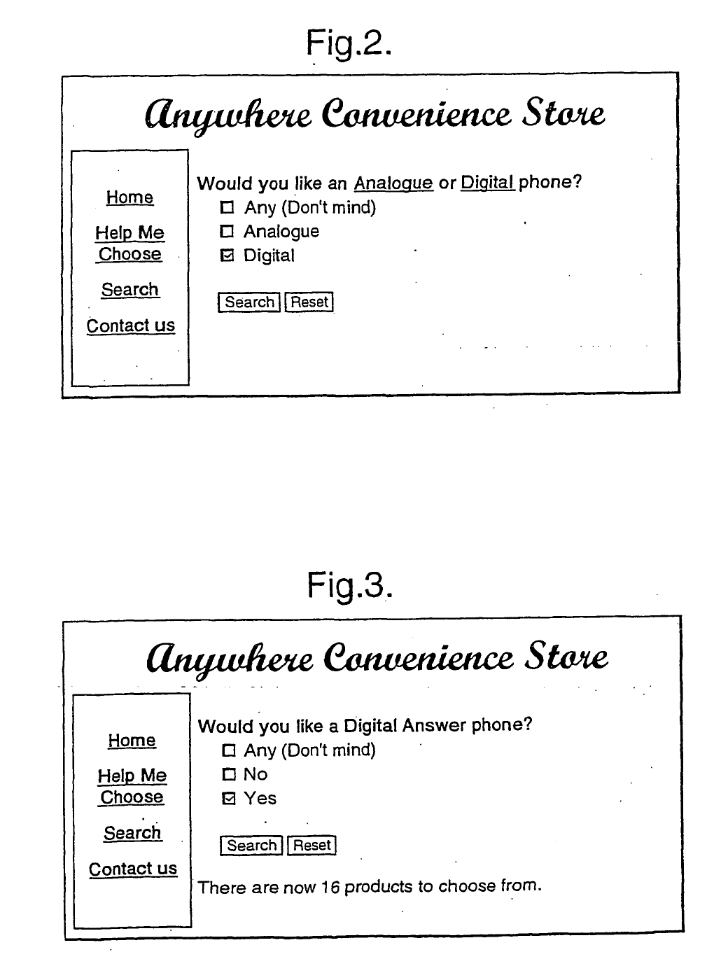

FIG. 2 illustrates an initial selection in a first example,

FIG. 3 illustrates a subsequent selection in the first example,

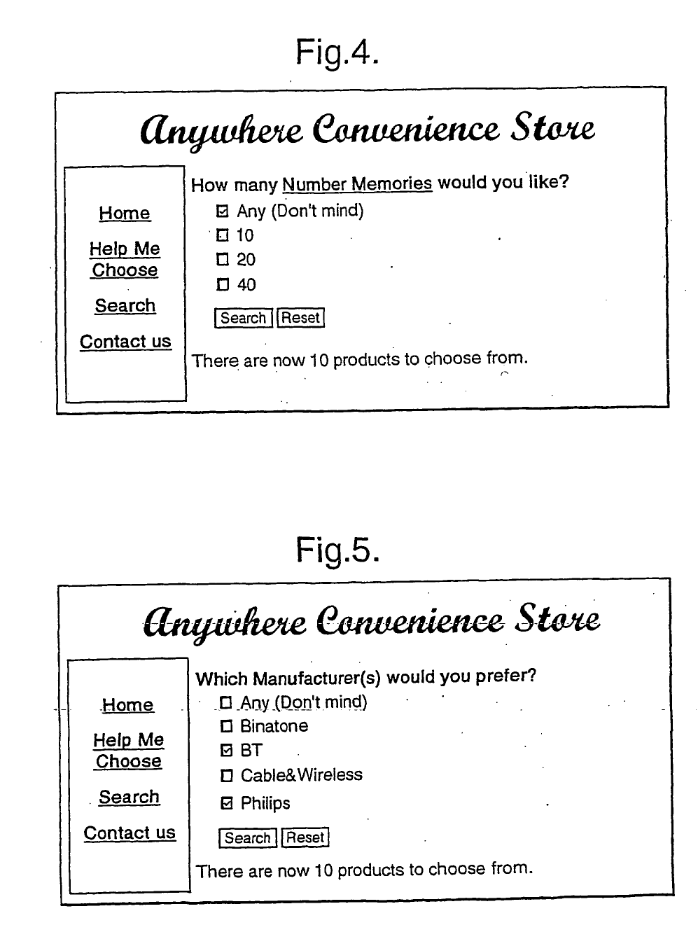

FIG. 4 illustrates a subsequent selection in the first example,

FIG. 5 illustrates a subsequent selection in the first example,

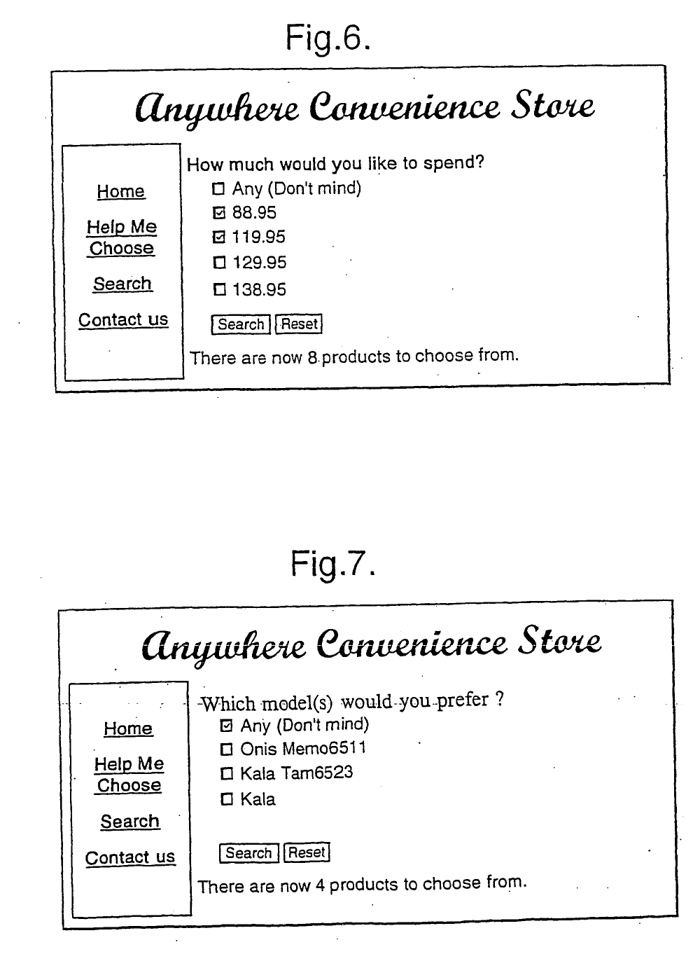

FIG. 6 illustrates a subsequent selection in the first example,

FIG. 7 illustrates a subsequent selection in the first example,

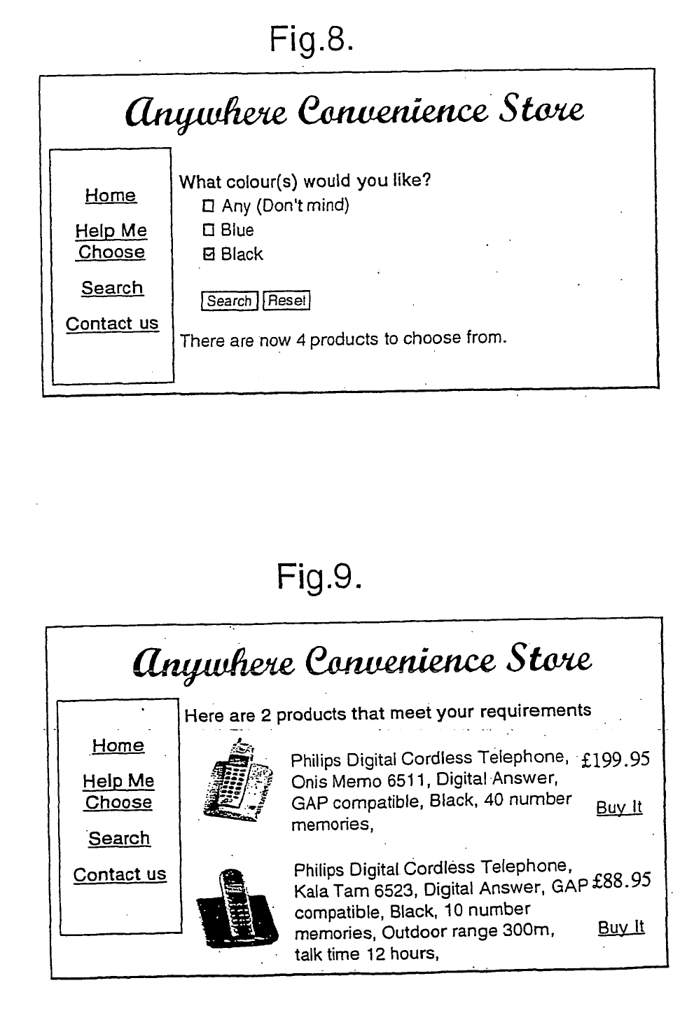

FIG. 8 illustrates a subsequent selection in the first example,

FIG. 9 illustrates a final selection in the first example,

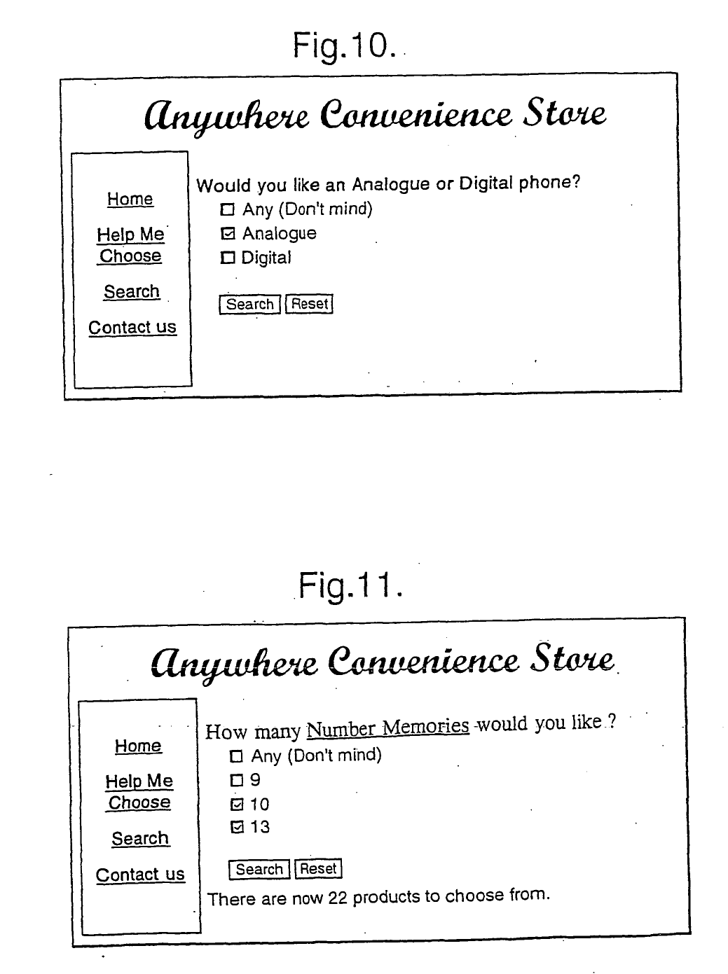

FIG. 10 illustrates an initial selection in a second example,

FIG. 11 illustrates a subsequent selection in the second example,

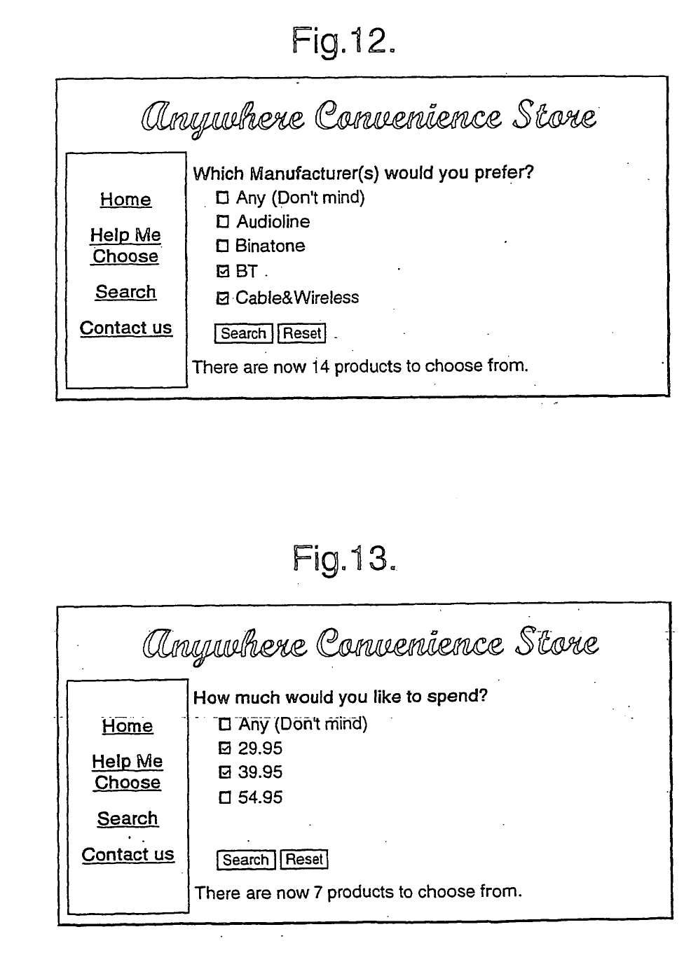

FIG. 12 illustrates a subsequent selection in the second example,

FIG. 13 illustrates a subsequent selection in the second example,

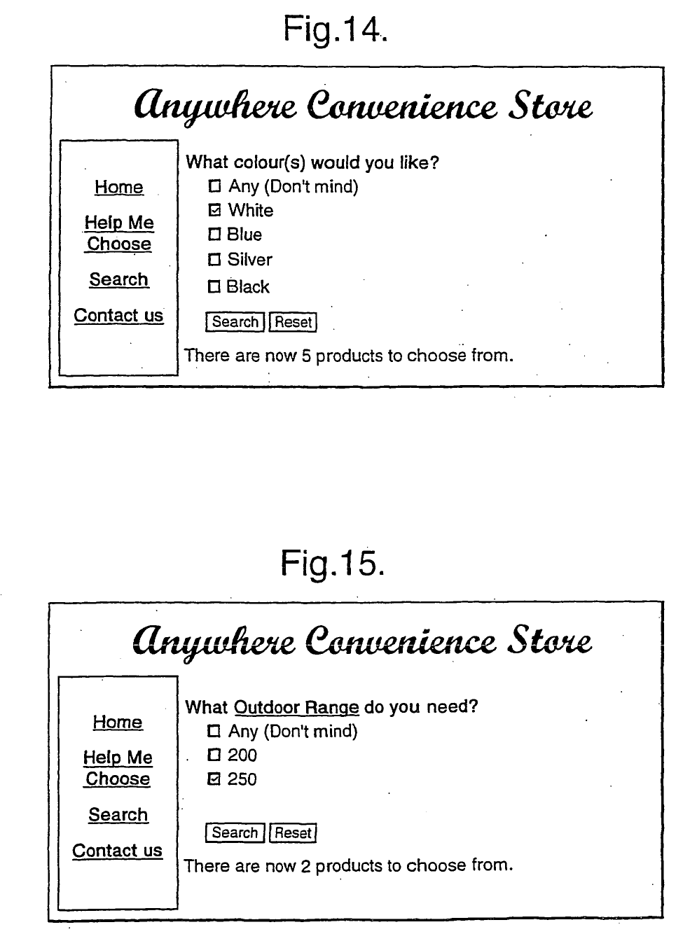

FIG. 14 illustrates a subsequent selection in the second example,

FIG. 15 illustrates a subsequent selection in the second example,

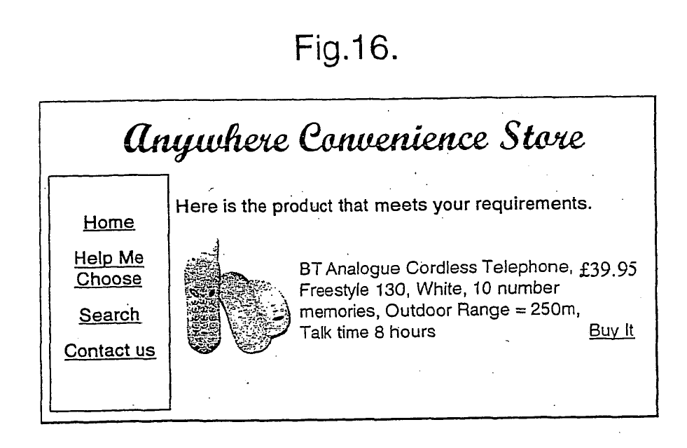

FIG. 16 illustrates a firm selection in the second example,

An embodiment of the present invention will be explained with reference to an example in which a user wishes to purchase a cordless telephone. In this embodiment the invention is implemented in software which interacts with a previously established Internet web site. The embodiment carries out the relevant processing and presents the relevant questions for user selection. It does not, however, control the look and feel of the web site pages. That is the specific layout, colours and fonts etc of the web pages are not controlled by the present invention in this embodiment thereof.

The web site has access to details of a range of cordless telephones. The first stage in the method of this embodiment is the provision of an information source having a respective product information for each of a plurality of products (cordless telephones), each product information comprising a plurality of attribute values each relating to a respective attribute of the product. FIG. 1 is an example of a database which acts as the information source in this embodiment. The database is a list of telephones and their respective attributes. As shown the attributes are: manufacturer, model, price, frequency GAP, colour, number of memories, outdoor range, indoor range, talk time digital answer. It will be noted that not all attributes have a specified value for each telephone. If no attribute value exists in the database for a particular attribute of a particular telephone then the value is considered to be null.

The next step in the method of this embodiment is the processing of each product information in the database so as to calculate a reduction benefit value for each attribute included in the database. The reduction benefit value is a measure of the reduction in the number of products available for selection which will result if a selection is made between the attribute values in the database for that attribute. The detail of this processing will be explained later.

After the reduction benefit values have been calculated, the software next makes an automatic selection of the attribute with the reduction benefit value which provides the largest reduction in the number of products available for selection. As will be explained in more detail below, in the present example the software determines that the attribute with the largest reduction benefit value is the attribute “frequency (D/A)”. Thus the products are now grouped according to their respective attribute value for the attribute “frequency (D/A)”, so as to form a plurality of product groups. These product groups are then presented for user selection therebetween. FIG. 2 illustrates the visual display screen as seen by the user. The product groups are “Analogue” and “Digital”. As will be seen from FIG. 1, “Analogue” and “Digital” are the only distinct values which appear in the database for the attribute “frequency (D)/A)”. As an optional feature, the choice to be made (between Analogue and Digital) has also been placed in the form of a question to prompt the user as to the selection to be made. The user makes the selection, in this embodiment, by using a mouse to click a check-box for the chosen option.

FIG. 2 also illustrates a further optional feature, which is the provision of an option (with an associated check-box) for “any” or “don't mind”. The user would select this option if the attribute of Analogue or Digital was not important in the users selection of a cordless telephone.

It is to be noted that the first question with which the user is faced is probably not associated with what the user would consider as the most important criteria in their selection of a cordless telephone. The user may not even care whether their final product selection is an analogue or a digital phone. The first question has instead been chosen simply on the basis of which attribute presents the largest reduction in the number of products which will remain for further selection.

After clicking one of the check-boxes, in the present embodiment the user clicks a button (marked “Search” in FIG. 2) so as to confirm the choice made. Once the users selection of product group (Analogue or Digital) has been accepted next the software re-calculates the reduction benefit values for the remaining attributes within the user selected product group or groups. Next the software automatically selects a remaining attribute, from the remaining attributes within the user selected product group, with the reduction benefit value which again provides the largest reduction in the number of products available for selection.

If the “any” or “don't mind” option is available and is selected by the user then the software simply presents the next selection without discarding any products on the basis of the attribute “frequency (D/A)”. That is, the number of products to choose from has not been reduced at all by the response to the first question.

In the present example, the user has selected “Digital” in response to the first question and it is the determined that of the remaining attributes, the attribute with the highest reduction benefit value is “digital answer”. That is the largest reduction in the number of telephones available for selection will now result from a choice between whether or not the telephone is equipped with a digital answer-phone facility. The corresponding display screen as seen by the user is shown in FIG. 3. Here it will be understood that the software has grouped the products from the user selected product group (digital cordless telephones) according to their respective attribute value (“Yes” or “No”) for the automatically selected remaining attribute (digital answer) so as to form a plurality of remaining product groups (those with and those without a digital answer-phone facility). As shown in FIG. 3, the remaining product groups are presented for user selection therebetween. As shown, the actual attribute values (“Yes”/“No”) are displayed. The remaining product groups could, of course, be equally well presented for user selection by other identifiers of the product groups, such as the labels “with answer-phone” and “without answer-phone”.

A further optional feature is shown in FIG. 3. Specifically, when the user is presented with the choice between products with an answer-phone or not, the user is also informed that there are at that stage 16 products left to choose from.

The user makes a choice by again clicking one of the check-boxes (including the possibility of the “don't mind” option) and subsequently clicking the “search” button to confirm the choice. The users choice of remaining product group is accepted and further processing is undertaken by the software.

As shown in FIG. 3, the user selects telephones having an answer-phone facility. There are at this stage 10 products left for further selection, ie 10 entries in the database for digital cordless telephones equipped with an answer-phone facility. This number is compared with a pre-set threshold. In the present example the threshold is set at 3. Since 10 is larger than the threshold, the software repeats the processing so as to present further selections to the user—until the number of products left for further selection is equal to or less than the threshold value of 3.

The remaining attribute with the largest reduction benefit value is the attribute of “number of memories”. The respective remaining product groups are formed and presented for user selection. This is shown in FIG. 4. Here three product groups are presented to the user namely, “10”, “20” and “40” (as well as the “don't mind” option). These are the three distinct attribute values among the products remaining for further selection—as can be ascertained from an analysis of FIG. 1.

As indicated in FIG. 4, the user does not mind how many memories the telephone has. As a consequence of the selection of the “don't mind” option, the software does not reduce the number of products available for selection based on the attribute of “number of memories”. That is, no products are excluded from further selection on the basis of their value for this attribute. The software simply continues the routine excluding this attribute from the further processing. Thus, the software determines the remaining attribute with the largest reduction value benefit is the attribute of “manufacturer”. Again remaining product groups are formed and are presented for user selection, as indicated by FIG. 5.

Of course, the optional extra which advises of the number of products remaining for selection still shows (in FIG. 5) that there are 10 products remaining—“don't mind” having been selected in FIG. 4.

As shown in FIG. 5, there are at this stage four product groups (plus “don't mind) to be selected between. FIG. 5 shows an example of the user selecting more than one product group. In this example, the user has selected products made either by BT or by Philips. Had the user selected one of the other two remaining manufactures, the final product selection (based on the entries in the database of FIG. 1) would then have been presented to the user—there being at this stage only one remaining product for each of the manufactures Binatone and Cable & Wireless. Nonetheless the software accepts the users selection of BT and Philips and proceeds again to select automatically the next attribute for reducing the number of products for selection—since the threshold of 3 has not yet been passed. In fact, there are now in this example 8 products left for further selection.

The software now determines that the remaining attribute with the largest reduction benefit value is the attribute of “price”. This attribute is selected automatically and the remaining product groups formed and presented to the user. FIG. 6 illustrates the display screen seen by the user at this stage. As indicated in FIG. 6, the user selects the two lower prices. This narrows the choice to 4 products, which is still more products than allowed for final user selection by the pre-set threshold value. The processing is thus repeated again.

The remaining attribute with the largest reduction benefit value at this stage is the attribute of “model”. There are 4 products remaining, but two of them are the same model (distinguished between them only by the attribute “colour”). The three product groups (three model names of the remaining products) are thus presented for user selection, as shown in FIG. 7. The user, perhaps not being familiar with the models, selects the “don't mind” option. The processing continues as before and the remaining attribute with the largest reduction benefit value is determined at this stage to be the attribute of “colour”. In fact an analysis of FIG. 1 will show that of the four remaining products three are coloured black and one is coloured blue. The remaining product groups “black” and “blue” are thus duly presented to the user, as indicated in FIG. 8. The user selects black.

With the user selection of black the number of products remaining for selection is 3, which is equal to the threshold. Consequently the previous routine is ceased and the final three products are presented to the user for final product selection. This is illustrated in FIG. 9, in which two of the remaining three products are displayed to the user (a scroll down operation being required to view the third product). The user can place a purchase order directly from this screen.

FIGS. 10 to 16 show the same example, but with the user making different selections. Even though the first question is the same as in FIG. 2, the subsequent sequence of options is different. This should be readily apparent from the description given above and thus a detailed explanation of the processing sequence for FIGS. 10 to 16 will not be given.

Calculation of the Reduction Benefit Value wilt now be described in detail. First, however, the general principle will be explained with reference to Table 1 set out below.

TABLE 1

| Product | Colour | Size |
|---|---|---|
| 1 | Black | Small |
| 2 | White | Small |
| 3 | Black | Medium |
| 4 | Black | Medium |
| 5 | Black | Medium |
| 6 | Black | Large |
| 7 | Blue | Large |

The purpose of the Reduction Benefit Value is to provide an indication of which attribute (Colour or Size) would, if used as the basis for selection, provide the largest reduction in the number of products to select from. In Table 1, the attributes have the following values:—

“Colour”

5×Black

1×White

1×Blue

“Size”

2×Small

3×Medium

2×Large

From Table 1, the attribute “Size” has the largest Reduction Benefit Value. This is because the more even distribution of attribute values means that whatever choice is made, the reduction in the number of products remaining for further selection will, on average, be less than would result from an initial selection made on the basis of “Colour” —which has a more uneven distribution of values.

In the above described embodiment of the present invention, the step of processing each product information so as to calculate a reduction benefit value for each attribute includes the step of processing each product information so as to calculate a reduction benefit value for each attribute value and calculating the reduction benefit value for each attribute as the sum of the reduction benefit values for each value of that attribute divided by the number of distinct values for that attribute. Specifically, the actual formula used by the above described embodiment of the present invention is as follows:—

RB=Sum(RB(n))/D

wherein;

RB is the reduction benefit value for the attribute,

RB(*n=(n/T)×((T−N−n)/T),

T is the total (remaining) number of products,

N is the number of products with a null value for the attribute,

D is the number of distinct attribute values, other than null, for the attribute, and

n is the number of products with a distinct, non-null, value for the attribute.

Using the example given in Table 1, the Reduction Benefit Values are as follows:—

Colour

Values: 5×Black, 1×White, 1×Blue

T=7

N=0 (since all products have a value for the attribute of Colour)

D=3 (Black, White, Blue)

RB (Black)=(5/7)×((70−0−5)/7) 10/49

RB (White)=(1/7)×((7−0−1)/7)=6/49

RB (Blue)=(1/7)×((7−0−1)/7) 6/49

RB=(10/49+6/49+6/49)/3=22/147=0.150

Size

Values: 2×Small, 3×Medium, 2×Large

T=7

N=0 (since all products have a value for the attribute of Size)

D=3 (Small, Medium, Large)

RRB (Small)=(2/7)×((7−0−2)/7)=10/49

RB (Medium)=(3/7)×((7−0−3)/7)=12/49

RB (Large)=(2/7)×((7−0−2)/7)=10/49

RB=(10/49+12/49+10/49)/3=32/147=0.218

Thus it can be seen that the Reduction Benefit Value for Size (0.218) is larger than the Reduction Benefit Value for Colour (0.150), indicating that an initial selection based on Size will on average more quickly reduce the number of products remaining for further selection than will an initial selection based on Colour.

Various examples and embodiments have been given above. Those examples and embodiments are not limiting of the invention, neither do they describe all of the possible variations. For example, in the database of FIG. 1, exact values have been given for the attribute of Price. Equally, of course, price ranges could have been specified in the database—for example allocation one of three price ranges (eg <£50, £50 to £100, >£100). Also, however, the software could involve more sophisticated processing which would take the exact price values given in FIG. 1 and from those itself calculate various price ranges. The product groups thus formed would not be formed directly on the attribute values but on sub-sets of those values.

It is apparent that the situation could arise in which more than one attribute equally has a reduction benefit value which provides the largest reduction. This can be accommodated for simply by making a random selection between these attributes. A non-random selection can be made by, for example, choosing between these attributes on the basis of which of them first appears in the database—or a more sophisticated solution can be adopted.

A variation of the examples shown in FIGS. 2 to 16 is to allow for more than one step of presenting for user selection to be conducted at the same time. That is several selections are displayed to the user at one time, with the presented product groups and/or presented remaining product groups being listed according to their relative reduction benefit values.

Another variation is to allow for, in a step of presenting remaining product groups to the user, also presenting the user with an option of bypassing subsequent steps in the method and proceeding to a presentation of all remaining products for final product selection by the user.

The description given above has been mainly in terms of the method steps used. The apparatus to implement the method is as follows:—

Apparatus for selecting a number of products from a plurality of products comprising:

storage means containing an information source having a respective product information for each of said plurality of products, each product information comprising a plurality of attribute values each relating to a respective attribute of the product;

processing means which process each product information so as to calculate a reduction benefit value for each attribute included in the information source wherein the reduction benefit value is a measure of the reduction in the number of products available for selection which will result if a selection is made between the attribute values in the information source for that attribute;

selecting means which select automatically the attribute with the reduction benefit value which provides the largest reduction;

grouping means which group the products according to their respective attribute value for the said automatically selected attribute so as to form a plurality of product groups;

means which present the product groups for user selection therebetween;

means which accept user selection of one or more product groups;

re-calculating means which re-calculate the reduction benefit values for the remaining attributes within the user selected product group or groups;

remainder selecting means which select automatically a remaining attribute, from the remaining attributes within the user selected product group or groups, with the reduction benefit value which provides the largest reduction;

remainder grouping means which group the products from the user selected product group or groups according to their respective attribute value for the said automatically selected remaining attribute so as to form a plurality of remaining product groups;

means which present the remaining product groups for user selection therebetween;

means which accept the user selection of one or more remaining product groups; and

means which present the products of the user selected remaining product group or groups for final product selection by the user.

Of course, the apparatus might comprise a processing unit which implements the said: processing means, selecting means, grouping means, re-calculating means, remainder selecting means, and remainder grouping means.

The aforegoing description has been given by way of example only and it will be appreciated by a person skilled in the art that modifications can be made without departing from the scope of the present invention. Some examples of modifications which can be made are as follows:—

1. Historical Usage Data

As described above, the “reduction benefit” formula works immediately on data it is presented with. However, it is possible to optionally bias it according to how users actually answer questions. For example, if users almost always choose “any” for a particular feature, then that feature should receive a lesser “reduction benefit”, since it does not usually help to reduce the number of products.

In practice, “real” historical reduction values can be blended with the calculated reduction benefit value. This allows actual usage to affect future results, whilst still keeping the system flexible to cope with changes to products and features.

3. The Full Reduction Benefit

The reduction benefit formula works solely on the number of products left. So if there were 100,000 products to start with, and there are only 15 left, then the formula works only on these 15.

However, in some cases there may also be a benefit in applying the reduction benefit value from the whole record set even when there are only a few products left. In the simplest case, when the reduction benefit value for two or more attributes is equal (when there are 15 products left), then the attribute with the largest reduction benefit value from the original 100,000 products can be chosen.

A more complex case would involve applying the full reduction benefit value calculated for the largest product group to the smaller product groups in changing proportions depending on the number of products left.

3. Yes/No Features

Features with just a Yes/No response can be handled as a special case. The problem is purely with user perception. For example, suppose the question is “Do you want a mute button on your ‘phone?” The answers being “Any”, “Yes”, “No”.

a) If the user wants the mute button, and answers “yes”, then only ‘phones with mute buttons are chosen and this is as required.

b) If the user does not consider a mute button important, then they may say “No” (i.e. no, I don't want a mute button). However, this would cause the system to only select ‘phones without mute buttons, and this may not be the desired response in this case. The user should perhaps have chosen “Any”, but was confused about the consequence of the answer.

To avoid this problem, two measures can be taken: Firstly, the “No” answer can be removed from the options, so the user can only choose “Yes” or “Any”. Secondly, since this affects how it can reduce the results, the reduction benefit can be altered. For example, this may be done by halving the “No” component of the reduction benefit for these cases, which would have the effect that Yes/No questions are less likely to be shown.

4. Max and Min

Some features are better expressed as a maximum/minimum, rather than a selection of values. For example, the number of bedrooms in a house. Instead of choosing which ones from 1/2/3/4/5 are required, the user can choose just one of “At least 1”, “At least 2”, etc.

The reduction benefit is calculated in exactly the same manner as described above. Thus, if “At least 2” is chosen, this translates into “2, 3, 4 and 5”. The max/min feature only affects how the feature is presented to the user.

5. Attribute Promotion

Sometimes the first question or attribute that is chosen automatically is not the most important one for the user. This is particularly true where there are monetary or geographical constraints. For example, when purchasing a house, the “price range” and “location” are significant.

Whenever external factors require certain attribute(s) to be presented to a user first, then they can be promoted in the system. This can be simply achieved by multiplying their reduction benefit values by a large number, e.g. 1000. This means that all the promoted attributes are presented first, but still in their ‘correct’ reduction benefit order, followed by the other attributes in their correct reduction benefit order.

6. Multiple Options (for an Attribute)

As hereinbefore described, each product has only one option for each attribute. For example, a product might have a colour of green only. In this multiple options variation, a product could have many options for each attribute.

The core algorithm remains fundamentally the same. The calculation can be carried out in the same manner as described above.

A slight variation is required for the question/answer format that is shown to the user, and in how products are “narrowed down”. For attributes with multiple options, the default is to select any product that matches. For example, FIG. 1 shows one blue/silver telephone. In the multiple options mode, a user might be presented with the options blue, white and silver. Suppose the user chooses blue and silver, then any products that have blue and silver available as a colour attribute, including the blue/silver telephone, are chosen. This is a “binary OR” operation.

However, the user may want to insist on choosing only products that are available in blue and silver together. To facilitate this, for a “multiple options” attribute only, an extra option can be offered, as follows:

“If you have chosen more than one option, tick this box if you want all of them. Leave it blank for a wider choice of any of them.”

If this is chosen, then a “binary AND” operation is performed, and only products matching all options are selected, instead of the standard “binary OR”.

Within the system there can be an option to switch off this automatic “choose all” option. This is for those cases where there might be multiple choices, but a binary AND search would be inappropriate.

This variation has so far been explained in terms of variations of a single attribute, namely colour. This technique can also work to group related attributes together. For example, suppose products were hotels, and different attributes were: swimming pool; golf course; and gym, each attribute representing whether the respective facility is available at a hotel.

With single options only, each attribute would give rise to a single Yes/No question. With multiple options, these can be grouped together under a “leisure activities” attribute. In the question presented to the user, the actual facility could be listed as an option under the “leisure activities” attribute. In this case, each hotel can have 0, 1, 2 or all 3 attributes.

7. As a “Search Results” Guide

The present invention has only been described up to now in terms of a guide that starts with all the products, and narrows down the product selection to the appropriate products.

As an alternative, the initial products can come from the results of a conventional search. For example, suppose the products were holidays. If someone entered “Tenerife” into a conventional search, they might receive 200 results (holidays). These can be passed to an apparatus according to the present invention, for operation just on these products to choose the best attribute (first question) as normal and then to proceed as previously described.

In other words, as well as providing an overall guide, an apparatus according to the present invention can supply an individual guide based on an arbitrary set of records/products. One single data set can be used in a large number of different situations, the best questions to ask being worked out each time.

8. Reducing the “Null” Effect.

In the present algorithm, if a feature/attribute has only one record with a value and the rest are null the reduction benefit becomes nil. This is undesirable.

Take for example the case where there are 5 phones, where one has “number of memories”=20 and the rest have an unknown (null) “number of memories”. In tis case, although “number of memories” is not an ideal attribute to choose, if it were the only one left, it would be better than nothing. Accordingly, a very low, but not zero, reduction benefit value is desirable.

In the aforegoing formula for the reduction benefit value, N represents' the number of null values, and is used in the term “(T−N−n)”. Where T is total number of products, N is number of null values, and a is the number of actual options In the “number of memories” example, T=5, N=4, and n=1. This results in 5−4−1=0. This term in the reduction benefit value formula is 0 and, since there is no other part to contribute any value, the whole reduction benefit value becomes zero.

To correct for this and still allow for the null values to have a “detrimental” effect on the reduction benefit value, the value of N can be reduced by a factor of, for example, 90%. Thus, N can be set N to “0.9N” before the calculation. Alternatively, the term in the formula itself can be changed to, for example, T−(0.9×N)−n.

9. Click Any

As hereinbefore described, a user chooses “Any” by ticking the “Any” box and scrolling to the bottom to click the “Search” button. Instead a link can be provided at the top of the screen (or from the “Any” text itself) that immediately jumps to the next question/attribute.

10. Data Preparation

The data in a data set can be further manipulated in a number of ways, as follows:

Merge—Where there are separate Yes/No attributes that are related and would work better together in a single attribute, they can be merged.

For example, suppose products were hotels, and different attributes were: swimming pool; golf course; and gym, each attribute representing whether the respective facility is available at a hotel. These attributes can be merged automatically to provide a single (multiple option) attribute of “Leisure” that combines them. This improves the usability of the system compared with asking a series of Yes/No questions.

Group—Attributes can also be grouped together to improve ease of use. For example, if there were Resorts in a holiday system, these could be grouped into countries, and the countries themselves into continents. This would generate 3 attributes that help narrow down the product choice in a step-by-step manner.

Spot same—In this modification, the system points out records/products which all have exactly the same features, thereby highlighting potential problems.

Confirmed null—A “Null” value is valid for the selection process. However when preparing data, a distinction can be made between a Null meaning “unknown” or “not relevant”, which is correct for the data, and a Null value that is there simply because the data hasn't been checked yet. This can occur when a new attribute is added to the data set, but not all the products have been checked against it.

1. An automated method of selecting a number of products from a plurality of products comprising the steps of:—
providing an information source having a respective product information for each of said plurality of products, each product information comprising a plurality of attribute values each relating to a respective attribute of the product;
processing each product information so as to calculate a reduction benefit value for each attribute included in the information source wherein the reduction benefit value is a measure of the reduction in the number of products available for selection which will, on average, result if a selection is made between the attribute values in the information source for that attribute;
automatically selecting the attribute with the reduction benefit value which provides the largest reduction;
grouping the products according to their respective attribute value for the said automatically selected attribute so as to form a plurality of product groups;
presenting the product groups for user selection therebetween;
accepting the user selection of one or more product groups;
re-calculating the reduction benefit values for the remaining attributes within the user selected product group or groups;
automatically selecting a remaining attribute, from the remaining attributes within the user selected product group or groups, with the reduction benefit value which provides the largest reduction;
grouping the products from the user selected product group or groups according to their respective attribute value for the said automatically selected remaining attribute so as to form a plurality of remaining product groups;
presenting the remaining product groups for user selection therebetween;
accepting the user selection of one or more remaining product groups; and
presenting the products of the user selected remaining product group or groups for final product selection by the user.

2. A method as claimed in claim 1, wherein including, in the event of more than one attribute equally having a reduction benefit value which provides the largest reduction, the step of random selection therebetween.

3. A method as claimed in claim 1 or claim 2, wherein the steps of: re-calculating the reduction benefit values for the remaining attributes within the user selected product group or groups, automatically selecting a remaining attribute, grouping so as to form a plurality of remaining product groups, presenting the remaining product groups, and accepting the user selection of one or more remaining product groups; are repeated a plurality of times, each based on the result of the previous, prior to the step of presenting products for final product selection by the user.

4. A method as claimed in claim 3, further comprising the step of allocating a pre-set threshold value to the said number in the said selecting a number of products and wherein the said repeating of steps a plurality of time continues until the number of remaining product groups is less than the pre-set threshold value.

5. A method as claimed in any preceding claim, wherein the step of presenting the product groups for user selection therebetween and/or one or more steps of presenting the remaining product groups for user selection therebetween includes the presentation of an “any”or “don't mind” option and wherein, in the event of selection of the “any” or “don't mind” option by the user, the subsequent step of re-calculating the reduction benefit values for the remaining attributes within the user selected product group or groups is omitted and in the subsequent step of automatically selecting a remaining attribute the plurality of remaining product groups is not reduced as a result of this user selection.

6. A method as claimed in any preceding claim, wherein the steps of calculating and of re-calculating a reduction benefit value for each attribute includes the step of processing each product information so as to calculate a reduction benefit value for each attribute value and calculating the reduction benefit value for each attribute as the sum of the reduction benefit values for each value of that attribute divided by the number of distinct values for that attribute.

7. A method as claimed in claim 6, wherein the steps of calculating and re-calculating a reduction benefit value for each attribute comprises calculating the reduction benefit value for each attribute in accordance with the formula:—
RB=Sum(RB(n))/D
wherein;
RB is the reduction benefit value for the attribute,
RB(n)=(n/T)×((T−N−n)/T),
T is the total (remaining) number of products,
N is the number of products with a null value for the attribute,
D is the number of distinct attribute values, other than null, for the attribute, and
n is the number of products with a distinct, non-null, value for the attribute.

8. A method as claimed in any preceding claim, wherein, at least once, more than one step of presenting for user selection is conducted at the same time with the presented product groups and/or presented remaining product groups being listed according to their relative reduction benefit values.

9. A method as claimed in any preceding claim, further comprising in a step of presenting remaining product groups to the user also presenting the user with an option of bypassing subsequent steps in the method and proceeding to a presentation of all remaining products for final product selection by the user.

10. A method as claimed in any preceding claim, further comprising in each step of presenting remaining product groups to the user also presenting to the user the numerical value of the number of products remaining for selection therebetween.

11. Apparatus for selecting a number of products from a plurality of products comprising:
storage means containing an information source having a respective product information for each of said plurality of products, each product information comprising a plurality of attribute values each relating to a respective attribute of the product;
processing means which process each product information so as to calculate a reduction benefit value for each attribute included in the information source wherein the reduction benefit value is a measure of the reduction in the number of products available for selection which will, on average, result if a selection is made between the attribute values in the information source for that attribute;
selecting means which select automatically the attribute with the reduction benefit value which provides the largest reduction;
grouping means which group the products according to their respective attribute value for the said automatically selected attribute so as to form a plurality of product groups;
means which present the product groups for user selection therebetween;
means which accept user selection of one or more product groups;
re-calculating means which re-calculate the reduction benefit values for the remaining attributes within the user selected product group or groups;
remainder selecting means which select automatically a remaining attribute, from the remaining attributes within the user selected product group or groups, with the reduction benefit value which provides the largest reduction;
remainder grouping means which group the products from the user selected product group or groups according to their respective attribute value for the said automatically selected remaining attribute so as to form a plurality of remaining product groups;
means which present the remaining product groups for user selection therebetween;
means which accept the user selection of one or more remaining product groups; and
means which present the products of the user selected remaining product group or groups for final product selection by the user.

12. Apparatus as claimed in claim 11, comprising a processing unit which implements the said: processing means, selecting means, grouping means, re-calculating the reduction benefit values for the remaining attributes within the user selected product group or groups, remainder selecting means, and remainder grouping means.

13. Apparatus as claimed in claim 11 or claim 12, wherein the various said means which present and the various said means which accept include a single visual display unit.

14. A data carrier having stored thereon a computer program which program when operational implements the method of any of claims 1 to 10.
